(19) United States
(12) Patent Application Publication
(10) Pub. No.: US 2013/0069895 A1
(43) Pub. Date: Mar. 21, 2013

(54) ELECTRICAL APPARATUS

(71) Applicants: Pi-Lin Lo, Taoyuan County (TW); Cheng-Yang Liao, Taoyuan County (TW); Cheng-Hsi Liu, Taoyuan County (TW); Yi-Fan Hsueh, Taoyuan County (TW); Te-Mu Chen, Taoyuan County (TW)

(72) Inventors: Pi-Lin Lo, Taoyuan County (TW); Cheng-Yang Liao, Taoyuan County (TW); Cheng-Hsi Liu, Taoyuan County (TW); Yi-Fan Hsueh, Taoyuan County (TW); Te-Mu Chen, Taoyuan County (TW)

(73) Assignee: HTC CORPORATION, Taoyuan County (TW)

(21) Appl. No.: 13/615,588

(22) Filed: Sep. 14, 2012

Related U.S. Application Data
(60) Provisional application No. 61/535,377, filed on Sep. 16, 2011.

(30) Foreign Application Priority Data
Jul. 13, 2012 (TW) 101125358

(51) Int. Cl. G06F 3/041

(52) U.S. Cl. 345/173

(57) ABSTRACT

An electrical apparatus having a panel is disclosed. The electrical apparatus includes a processor, a touch controller and a display driver. The processor unitsets one of a scan frequency and a display frequency to be a setting frequency, and generates the other of the scan frequency and the display frequency based on the setting frequency. The touch controller makes the panel detects a touch based on the scan frequency, and the display driver makes the panel display images based on the display frequency. The touch controller detects a noise detected value from the electrical apparatus. The touch controller or the processor unitadjusts the setting frequency based on the noise detected value, and adjusts the touch scan frequency or the display frequency which is not the setting frequency based on the setting frequency.

### CROSS-REFERENCE TO RELATED APPLICATION

This application claims the priority benefits of U.S. provisional application Ser. No. 61/535,377, filed on Sep. 16, 2011 and Taiwan application serial no. 101125358, filed on Jul. 13, 2012. The entirety of each of the above-mentioned patent applications is hereby incorporated by reference herein and made a part of this specification.

### TECHNICAL FIELD

The disclosure relates to an electrical apparatus, and more particularly to a method for setting and dynamically switching a working frequency of the electrical apparatus.

### BACKGROUND

As electrical technologies progress, it is a trend to provide a modern consumer product with a display panel having a touch function for a user to directly touch to control a picture and/or a text. To save a space occupied by an electrical product, the designer(s) provide(s) a panel with touch and display functions by integrating a display panel and a touch panel.

When generating too many noises, the conventional integrated electrical apparatus adjusts a frequency which is used by the electrical apparatus for detecting a touch, thereby lowering a noise likely to be generated by the electrical apparatus on an original working frequency used for detecting the touch. However, a frequency usable by the electrical apparatus for detecting the touch is closely related to a display frequency used by the electrical apparatus for performing displaying. As a result, a adjusting range of the frequency used by the electrical apparatus for detecting the touch falls in a certain limited range. Therefore, a scanning frequency cannot be adjusted to a level for effectively lowering the noise generated by the electrical apparatus while taking a quality of a display operation into consideration.

Please refer to FIG. 1, FIG. 1 illustrates a block diagram of a conventional electrical apparatus 100. The electrical apparatus 100 includes a system end 110, a processor unit 120 and a panel 130. The processor unit 120 sends a signal TS to scan a plurality of touch detecting endpoints on the panel 130. The processor unit 120 also receives a signal RS sent back by the panel 130 based on the above scan operation to acquire a touch sensing condition of the panel 130. Since a scan time or a charge time required by a far-end touch point FN on the panel 130 is longer than a scan time or a charge time required by a near-end touch point NN, the conventional electrical apparatus 100 often sets the scan time or charge time required by the far-end touch point FN to be a basis of a scan time or a charge time for all the touch points on the panel 130.

However, in a setting condition where a scan time or a charge time required is longer, an environment noise (including a noise on the panel 130 and a noise on a ground-engaging end of the apparatus) is more likely to be coupled in the conventional electrical apparatus 100. Accordingly, it is an important issue to lower the aforementioned noise to enhance a capability of the electrical apparatus 100.

### SUMMARY

The disclosure provides an electrical apparatus and a method for setting a working frequency thereof for dynamically adjusting the working frequency of the electrical apparatus based on the generation of a noise.

The disclosure provides an electrical apparatus having a panel. The panel may be either an embedded touch panel or an out-cell touch panel. The embedded touch panel may be an in-cell touch panel or an on-cell touch panel. The electrical apparatus also includes a processor unit, a sense circuitry and a drive circuitry. The panel includes a plurality of touch units and a plurality of display units. The processor unit sets a scan frequency and a display frequency. The sense circuitry is coupled to the processor unit and the panel. The sense circuitry receives the scan frequency and makes the panel detect the touch units based on the scan frequency. The drive circuitry is coupled to the sense circuitry and the panel. The drive circuitry receives the display frequency and makes the panel display an image of the display units based on the display frequency. The sense circuitry detects a noise value of the touch units. The processor unit adjusts the scan frequency and the display frequency based on the noise value.

The disclosure provides an electrical apparatus which includes a panel, a sense circuitry and a drive circuitry. The panel includes a plurality of touch units and a plurality of display units. The sense circuitry sets a scan frequency. The sense circuitry is coupled to the panel. The sense circuitry receives the scan frequency and makes the panel detect the touch unit based on the scan frequency. The drive circuitry sets a display frequency. The drive circuitry is coupled to the sense circuitry and the panel. The drive circuitry receives the display frequency and makes the panel display an image of the display units based on the display frequency. The sense circuitry detects a noise value of the touch units. The sense circuitry adjusts the scan frequency or the display frequency based on the noise value.

The disclosure also provides a method for setting a working frequency of an electrical apparatus, including: first, setting one of a scan frequency and a display frequency to be a setting frequency and generating the other of the scan frequency and the display frequency based on the setting frequency, thereafter, detecting a noise detected value of the electrical apparatus, adjusting the setting frequency based on the noise detected value and adjusting the scan frequency or the display frequency which is not the setting frequency based on the setting frequency.

Based on the aforementioned, the disclosure performs a real-time detection on the noise from the electrical apparatus and uses the noise detected value being detected to dynamically adjust the scan frequency and the display frequency of the electrical apparatus. As a result, the scan frequency and the display frequency of the electrical apparatus may be adjusted to a better frequency so that the electrical apparatus may operate under a condition with a stable display quality and a lowered noise to achieve the best capability.

In order to make the aforementioned features and advantages of the disclosure more comprehensible, embodiments accompanying figures are described in detail below.

### BRIEF DESCRIPTION OF THE DRAWINGS

FIG. 1 illustrates a block diagram of a conventional electrical apparatus 100.

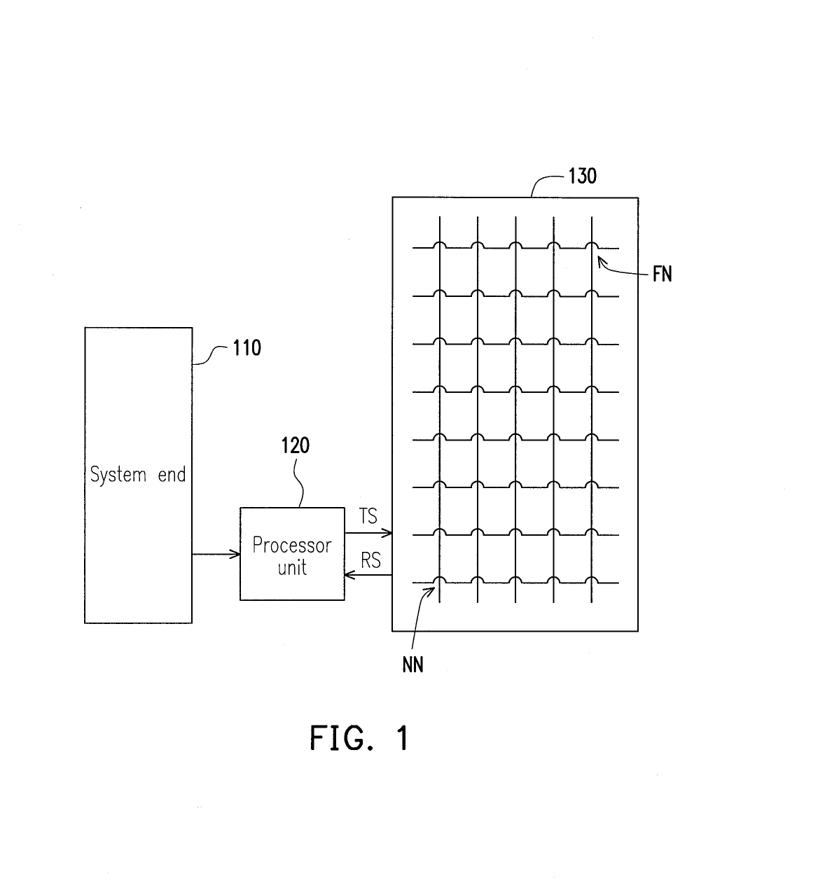

FIG. 2A illustrates a schematic view of an electrical apparatus 200 in an embodiment of the disclosure.

FIG. 2B illustrates a schematic view of an electrical apparatus 200 in another embodiment of the disclosure.

FIG. 3 illustrates a method for setting a working frequency of an electrical apparatus in an embodiment of the disclosure.

FIG. 4A illustrates an implementation flow chart of the method for setting the working frequency of the electrical apparatus.

FIGS. 4B and 4C illustrate an oscillogram of setting the working frequency of the electrical apparatus.

FIGS. 5A-5D illustrate a cross-sectional view of an implementation method of a panel 500 in an embodiment of the disclosure.

### DESCRIPTION OF EMBODIMENTS

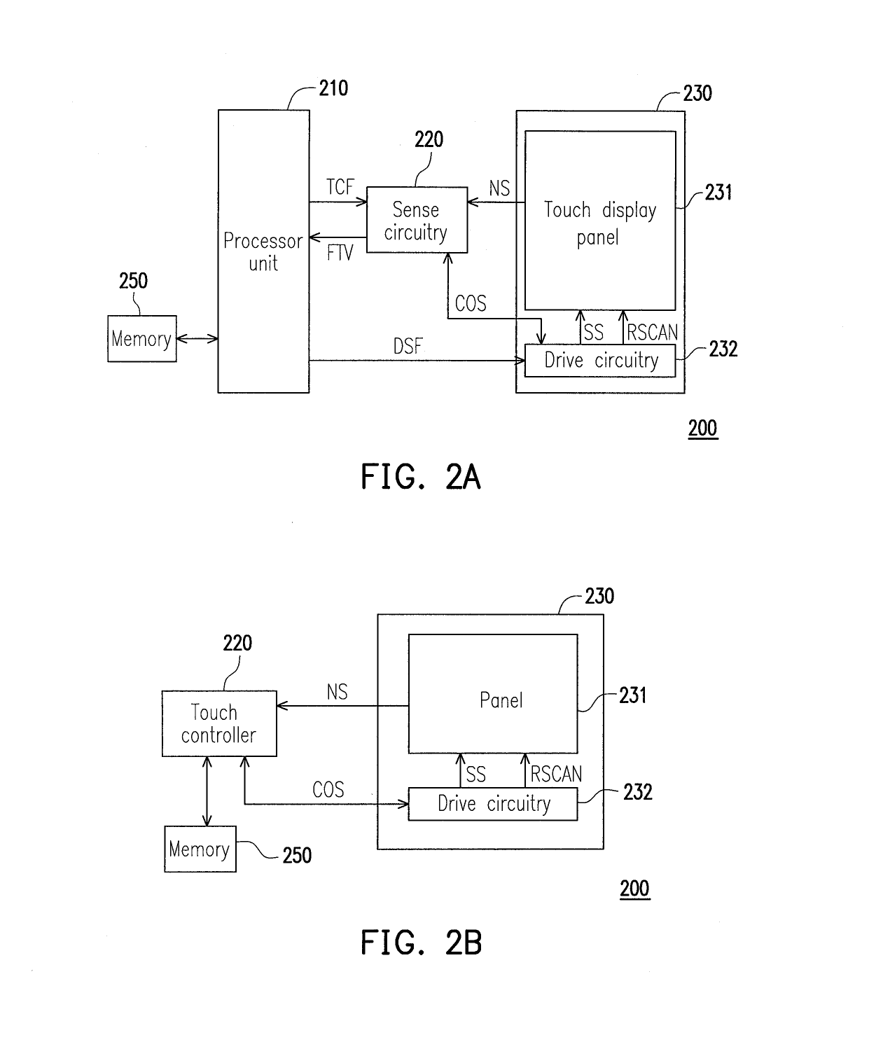

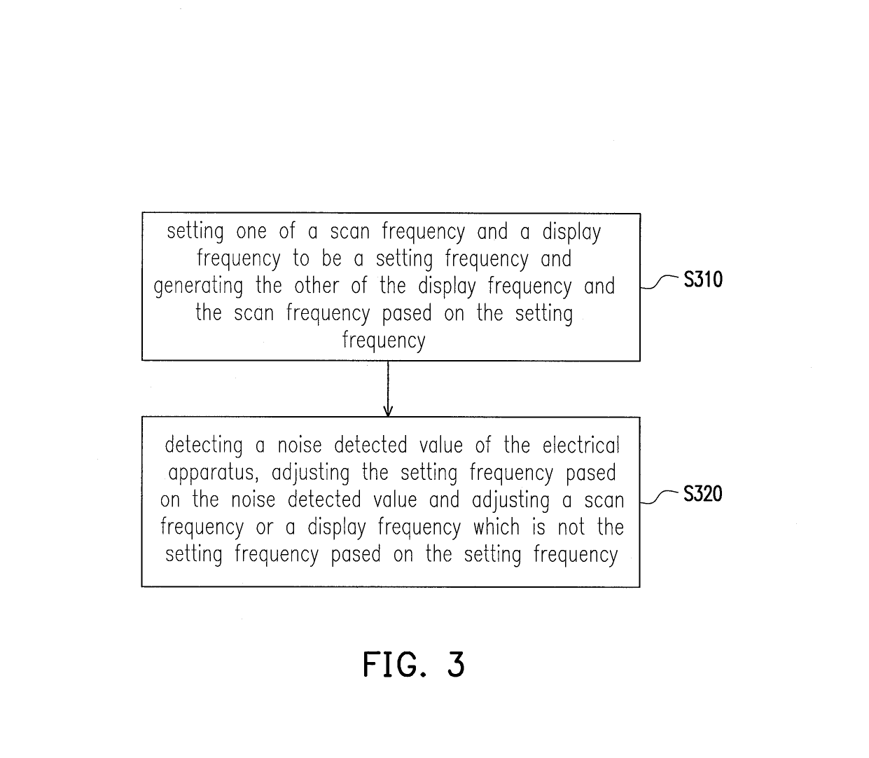

Please refer to FIG. 2A first, FIG. 2A illustrates a schematic view of an electrical apparatus 200 in an embodiment of the disclosure. The electrical apparatus 200 includes a processor unit 210, a sense circuitry 220, a memory 250, a drive circuitry 232 disposed in a display module 230 and a panel 231, wherein the panel 231 integrates a plurality of touch detected units which detects a touch and a display panel which displays a picture. In order for an image being displayed not to be disturbed, the touch detected unit may be formed from a transparent conductive film which comprises indium tin oxide (ITO) which is light transmissible. The panel 231 includes a plurality of touch units and a plurality of display units.

The processor unit 210 is coupled to the sense circuitry 220 and the drive circuitry 232. The processor unit 210 sets a scan frequency TCF and a display frequency DSF respectively, and transmits the scan frequency TCF and the display frequency DSF being set to the sense circuitry 220 and the drive circuitry 232. The sense circuitry 220 receives the scan frequency TCF and makes the panel 231 detect a touch based on the scan frequency TCF received. The drive circuitry 232 receives the display frequency DSF and drives the panel 231 to display an image based on the display frequency DSF received as well as carries out touch scanning operation on the panel 231. To be specific, the drive circuitry 232 generates a scan signal SS based on the scan frequency TCF, and the sense circuitry 220 detects the touch on the panel 231 based on the scan frequency TCF. The scan signal SS generated by the drive circuitry 232 carries out touch scanning to the panel 231. The drive circuitry 232 also generates, for example, a row scan line (RSCAN) signal to drive the panel 231 to display the image. In addition, the drive circuitry 232 and the sense circuitry 220 may also communicate with each other through transmitting a signal COS to each other. That is, the drive circuitry 232 may inform the drive circuitry 232 a message of the scan frequency TCF via the signal COS.

It is worth mentioning that there is a close relation between the above row scan line signal RSCAN and the scan signal SS so they cannot be set independently in a separate manner. For example, a time point in which the scan signal SS scans and detects the touch on the panel 231 cannot overlap with a time point in which the row scan line signal RSCAN enables any of display lines in the panel 231 to display the picture. That is, the scan signal SS may perform scanning and detecting the touch on the panel 231 when all display rows are closed. That is, when the display frequency DSF based on which the row scan line signal RSCAN is generated is adjusted, the scan frequency TCF based on which the scan signal SS is generated has to be adjusted correspondingly, and vice versa.

With the above restrictions, in the embodiments of the disclosure, the processor unit 210 first sets the scan frequency TCF and the display frequency DSF for the electrical apparatus 200 to which the processor unit 210 belongs. When the processor unit 210 sets the scan frequency TCF and the display frequency DSF, the scan frequency TCF may be set first, then the display frequency DSF is correspondingly set based on a relation between the scan frequency TCF and the display frequency DSF. Of course, the processor unit 210 may also set the display frequency DSF first and then correspondingly set the scan frequency TCF based on the relation between the scan frequency TCF and the display frequency DSF. That is, the processor unit 210 may set one of the scan frequency TCF and the display frequency DSF to be a setting frequency, and then generate the other of the corresponding scan frequency TCF and the display frequency DSF based on the setting frequency.

That is, if the processor unit 210 sets the scan frequency TCF first, the processor unit 210 further sets the display frequency DSF through the corresponding relation between the scan frequency TCF and the display frequency DSF based on the scan frequency TCF being set. Relatively, if the processor unit 210 sets the display frequency DSF first, the processor unit 210 further sets the scan frequency TCF through the corresponding relation between the scan frequency TCF and the display frequency DSF based on the display frequency DSF being set.

The memory 250 is coupled to the processor unit 210, and a table is saved in the memory 250. A plurality of scan frequency to be selected and a plurality of corresponding display frequency to be selected are arranged in the table. When the processor unit 210 sets the scan frequency TCF first, the processor unit 210 selects one of the plurality of the scan frequency to be selected in the table to set the scan frequency TCF, and then locates a display frequency to be selected corresponding to the scan frequency TCF from the plurality of display frequency to be selected in the table to set to be the display frequency DSF. Correspondingly, when the processor unit 210 sets the display frequency DSF first, the processor unit 210 selects one of the plurality of the display frequency to be selected in the table to set the display frequency DSF, and then locates a scan frequency to be selected corresponding to the display frequency DSF from the plurality of scan frequency to be selected in the table to set to be the scan frequency TCF.

After finishing setting the scan frequency TCF and the display frequency DSF, the sense circuitry 220 instantly detects a noise value NS generated by the electrical apparatus 100 under a set working frequency (the scan frequency TCF and the display frequency DSF). A frequency adjusting value FTV may be determined by the processor unit 210 or the sense circuitry 220 based on the detected noise value NS. If the frequency adjusting value FTV is determined by the sense circuitry 220, the frequency adjusting value FTV has to be transmitted to the processor unit 210, so as to adjust the scan frequency TCF and the display frequency DSF through the processor unit 210. Precisely, the processor unit 210 or the sense circuitry 220 compares a noise detected value obtained from the detected noise value NS with a threshold value. When the noise detected value is greater than or not less than the threshold value, an instruction is generated requiring the frequency adjusting value FTV which adjusts the scan frequency TCF and the display frequency DSF. Relatively, when the noise detected value is not greater than or less than the threshold value, the frequency adjusting value FTV which adjusts the scan frequency TCF and the display frequency DSF is not required by the processor unit 210 or the sense circuitry 220.

When the processor unit 210 receives the instruction requiring the frequency adjusting value FTV which adjusts the scan frequency TCF and the display frequency DSF, the processor unit 210 adjusts the scan frequency TCF or the display frequency DSF being set to be the setting frequency. Then the processor unit 210 adjusts the other of the scan frequency TCF and the display frequency DSF via the aforementioned relation between scan frequency TCF and the display frequency DSF based on one of an updated scan frequency TCF and an updated display frequency DSF.

The processor unit 210 also transmits the updated scan frequency TCF and the updated display frequency DSF to the sense circuitry 220 and the drive circuitry 232, respectively, so as to enable the electrical apparatus 200 to operate under an updated working frequency (the scan frequency TCF and the display frequency DSF).

Please note that the processor unit 210 may adjust the setting frequency through adding or deducting a frequency adjusting value which is set in advance to/from an original frequency of the setting frequency (the scan frequency TCF or the display frequency DSF). Or, the processor unit 210 may also adjust the setting frequency through multiplying or dividing the original frequency of the setting frequency by a ratio which is set in advance. In order to prevent a discrepancy between a frequency value of the setting frequency and a frequency value which is set from the outset from being too big, the processor unit 210 may adjust the setting frequency within a certain frequency range. That is, when the setting frequency is adjusted by adding up the frequency adjusting value, after a number of adjustments to the setting frequency, the setting frequency may exceed a top limit of the frequency range. Then the setting frequency may be adjusted by deducting the frequency adjusting value. In reverse, when the setting frequency is lower than a lower limit of the frequency range, the setting frequency may be adjusted by adding up the frequency adjusting value. It is worth mentioning that the frequency adjusting value may be formulated by a designer based on an actual condition. The key is that to effectively decrease a noise within the least adjustments to the frequency.

When the processor unit 210 adjusts the scan frequency TCF, the processor unit 210 needs to locate a scan frequency to be adjusted which is most close to a scan frequency based on the above calculation from the plurality of the scan frequency to be selected in the memory 250 to adjust the scan frequency TCF, and then locate a display frequency corresponding to a adjusted scan frequency TCF to adjust the display frequency DSF.

Then please refer to FIG. 2B, FIG. 2B illustrates a schematic view of an electrical apparatus 200 in another embodiment of the disclosure. Different from the former embodiment, the electrical apparatus 200 does not need assistance of the processor unit 210 to set and adjust a scan frequency and a display frequency. In the embodiment, the scan frequency and the display frequency may be set and adjusted through a sense circuitry 220. That is, in the former embodiment, a setting and adjusting performed to the scan frequency and the display frequency by the processor unit 210 is performed by the sense circuitry 220. The sense circuitry 220 may transmit the scan frequency and the display frequency to a drive circuitry 232 through a transmitting method of a signal COS. In addition, a memory 250 is coupled to the sense circuitry 220. The memory 250 also provides a table to provide a basis for setting the sense circuitry 220 and adjusting the scan frequency or the display frequency.

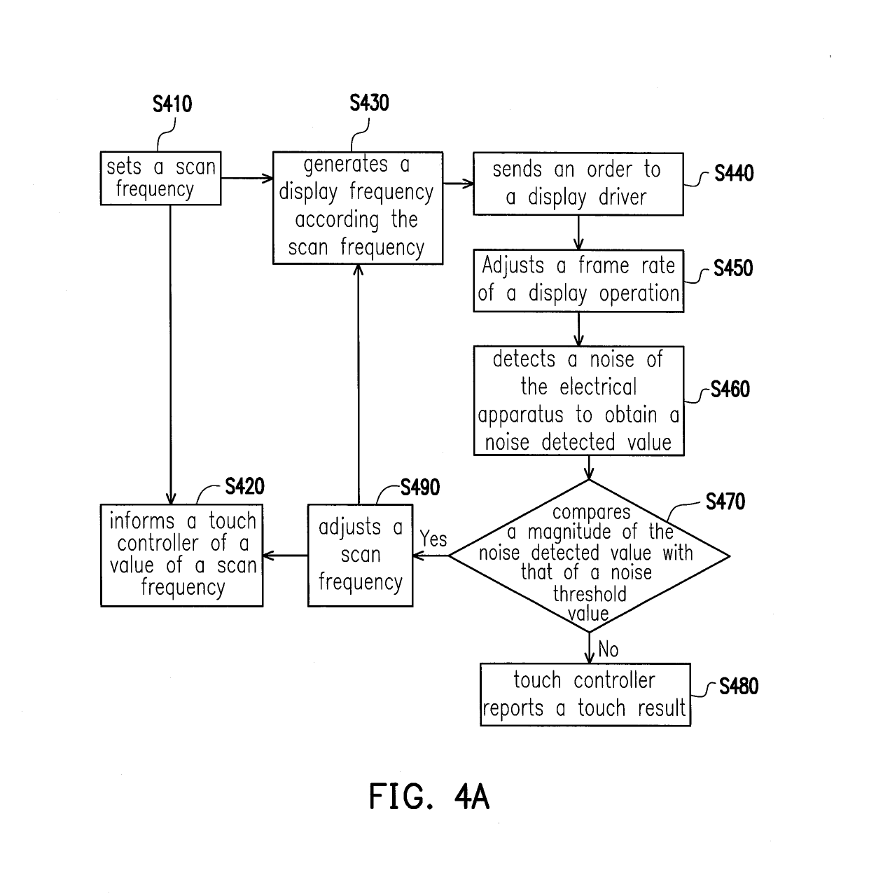

Then please refer to FIG. 3, FIG. 3 illustrates a method for setting a working frequency of an electrical apparatus in an embodiment of the disclosure, including steps of: first, setting one of a scan frequency and a display frequency to be a setting frequency and generating the other (S310) of the scan frequency and the display frequency based on the setting frequency, then detecting a noise detected value of the electrical apparatus, adjusting the setting frequency based on the noise detected value and adjusting a scan frequency or a display frequency (S320) which is not the setting frequency based on the setting frequency.

In order to describe the method for setting the working frequency of the electrical apparatus in the embodiment of the disclosure in a clearer way, an actual example is provided and described below.

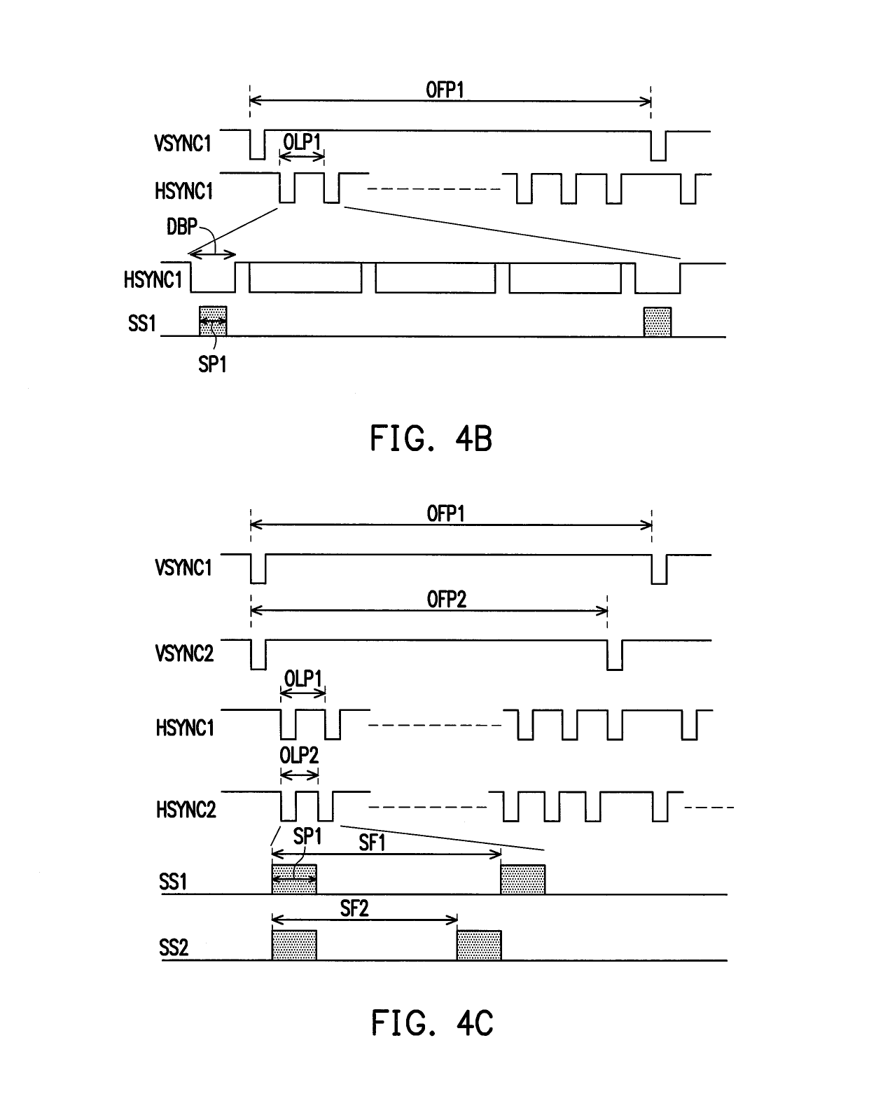

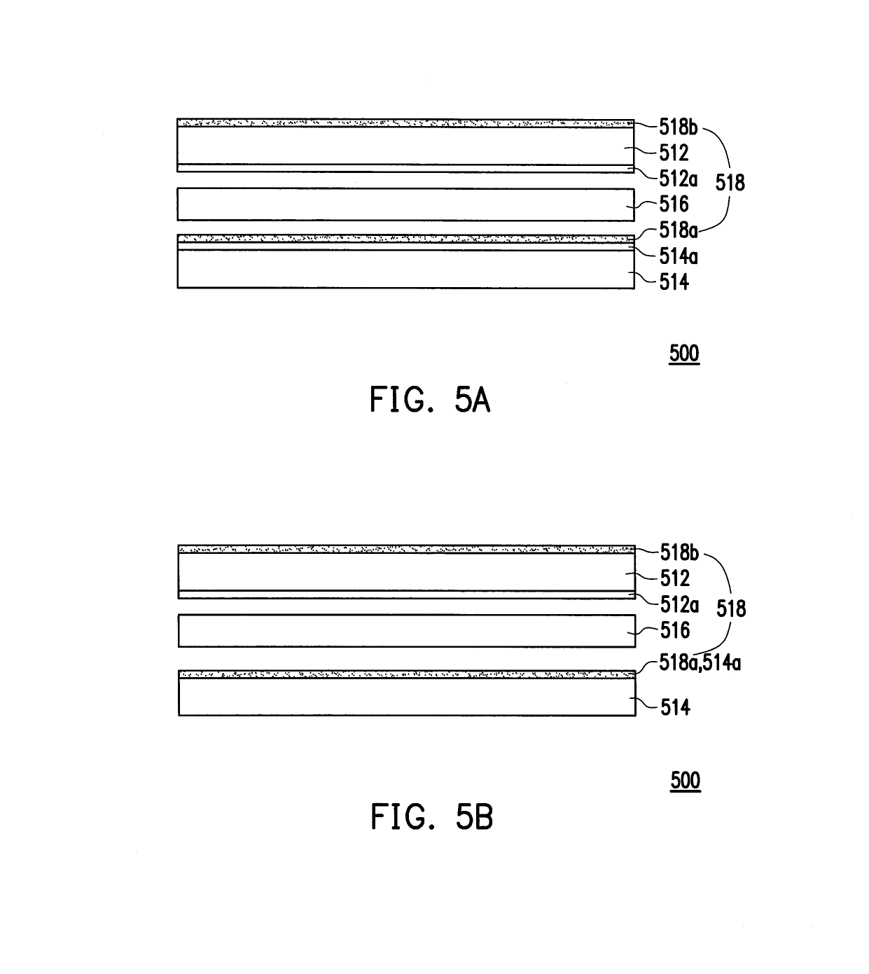

Please refer to FIG. 4A, FIG. 4A illustrates an implementation flow chart of the method for setting the working frequency of the electrical apparatus. In the embodiment, a processor unit sets a scan frequency to be a setting frequency (S410) and generates a display frequency (S430) according the scan frequency. A readily set scan frequency in the step S410 is provided to a sense circuitry so that the sense circuitry acquires a value (S420) of the scan frequency. In addition, the processor unit sends an order to a drive circuitry (S440), with which the processor unit completes adjusting a frame rate of a display operation. Moreover, the sense circuitry detects a noise of the electrical apparatus to obtain a noise detected value (S460) and compares a magnitude of the noise detected value with that of a threshold value (S470). In the embodiment, when the noise detected value is greater than the threshold value, the processor unit correspondingly adjusts the scan frequency and re-informs the sense circuitry of the updated scan frequency. In reverse, when the noise detected value is not greater than the threshold value, the sense circuitry reports a touch result (S480).

In addition, when the step 490 is executed, the processor unit correspondingly adjusts the display frequency.

Please refer to FIGS. 4B and 4C for the following description. FIGS. 4B and 4C illustrate an oscillogram of setting a working frequency of an electrical apparatus. In an illustration of FIG. 4B, a vertical synchronization signal VSYNC1 and a horizontal synchronization signal HSYNC1 set a display scan operation performed on a panel. Furthermore, a frame period OFP1 includes a plurality of row periods OLP1. During a display blank period DBP1 when the horizontal synchronization signal HSYNC1 is equivalent to a low level voltage, the panel may perform the touch scan operation based on a scan signal SS1.

In addition, in an illustration of FIG. 4C, when a scan frequency is adjusted, a display frequency is correspondingly adjusted. In the embodiment, a frequency SF2 of an adjusted scan signal SS2 is speeded up (a period SF1 of the scan signal SS1 is longer than a period SF2 of the scan signal SS2). Therefore, a frequency of an adjusted vertical synchronization signal VSYNC2 and a frequency of a horizontal synchronization signal HSYNC2 are speeded up. Relatively, an adjusted frame period OFP2 and an adjusted row period OLP2 are correspondingly shortened.

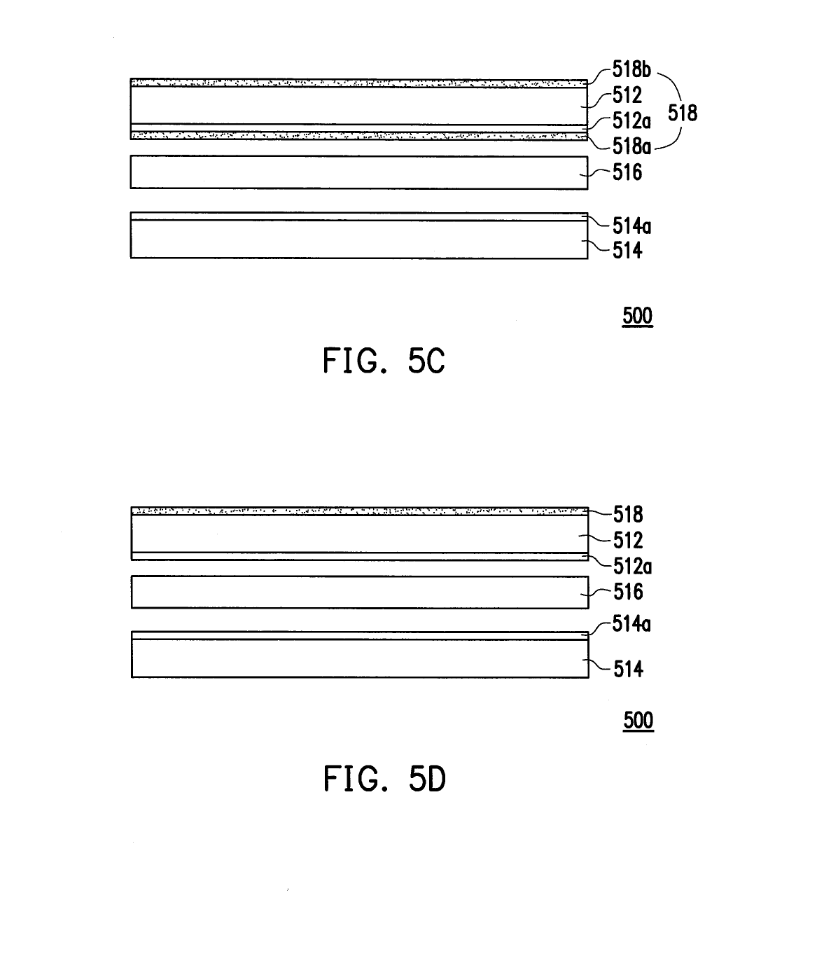

Please refer to FIG. 5A for the following description. FIG. 5A illustrates a cross-sectional view of an implementation of a panel 500 in an embodiment of the disclosure. The panel 500 has an upper basement layer 512, a lower basement layer 514 and a crystal layer 516. In the embodiment, the upper basement layer 512 may be a color filter basement layer having a color filter layer 512a, and the lower basement layer 514 may be a thin film transistor array basement layer having a thin film transistor array 514a. The crystal layer 516 is sandwiched between the upper basement layer 512 and the lower basement layer 514. The panel 500 further includes a capacitive touch sensing layer 518. The capacitive touch sensing layer 518 has a first conductive layer 518a (for example, comprising indium tin oxide (ITO)), wherein the first conductive layer 518a has an electrode disposed on an upper surface of the lower basement layer 514 for receiving a signal. The capacitive touch sensing layer 518 also has a second conductive layer 518b (for example, comprising ITO), wherein the second conductive layer 518b has an electrode disposed on an upper surface of the upper basement layer 512 for sending a signal and sending the signal to the sense circuitry so as to calculate a touch position generated on a panel by a user. The first conductive layer 518a is disposed on the thin film transistor array 514a.

Please refer to FIG. 5B for the following description. FIG. 5B illustrates a cross-sectional view of another implementation method of the panel 500 in the embodiment of the disclosure. The first conductive layer 518a and the thin film transistor array 514a integrate with each other and use a gate electrode scan line on the thin film transistor array 514a to be the electrode.

Next please refer to FIGS. 5C and 5D, FIGS. 5C and 5D illustrate a cross-sectional view of a plurality of implementation methods of the panel 500 in the embodiment of the disclosure. In an illustration of FIG. 5C, the first conductive layer 518a may be formed at a lower surface of the upper basement layer 512. Or, as illustrated in FIG. 5D, the first conductive layer 518a and the second conductive layer 518b are formed on a same layer to form a single layer capacitive touch sensing layer 518, which is formed on the upper surface of the upper basement layer 512. In addition, the single layer capacitive touch sensing layer 518 may also be formed at the lower surface of the upper basement layer 512 (not shown).

In summary, the disclosure adjusts one of a scan frequency and a display frequency based on a condition of a noise generated by an electrical apparatus and correspondingly adjusts the other of the scan frequency and the display frequency. Accordingly, the scan frequency and the display frequency of the electrical apparatus may be easily and effectively adjusted in a dynamic way so that the electrical apparatus may effectively decrease the noise while taking a display quality into consideration.

Although the disclosure has been disclosed by the above embodiments, the embodiments are not intended to limit the disclosure. It will be apparent to those skilled in the art that various modifications and variations may be made to the structure of the disclosure without departing from the scope or spirit of the disclosure. Therefore, the protecting range of the disclosure falls in the appended claims.

What is claimed is:

1. An electrical apparatus, comprising:
a panel, comprising a plurality of touch units and a plurality of display units;
a processor unit, the processor unit sets a scan frequency and a display frequency;
a sense circuitry, coupled to the processor unit and the panel, wherein the sense circuitry scan the touch units in the panel based on the scan frequency; and
a drive circuitry, coupled to the processor unit and the panel, wherein the drive circuitry drives the display units in the panel based on the display frequency,
wherein, the touch controller detects a noise value of the touch unit, and the processor unit adjusts the scan frequency or the display frequency based on the noise value.

2. The electrical apparatus based on claim 1, wherein the processor unit determines the scan frequency, and the processor unit generates the display frequency based on the scan frequency being set.

3. The electrical apparatus according to claim 1, wherein the processor unit determines the display frequency, and the processor unit generates the scan frequency based on the display frequency being set.

4. The electrical apparatus according to claim 1, wherein the processor unit adjusts the scan frequency based on the noise value and adjusts the display frequency based on the scan frequency being tuned.

5. The electrical apparatus according to claim 1, wherein the processor unit adjusts the display frequency based on the noise value and generates the scan frequency based on the display frequency being adjusted.

6. The electrical apparatus according to claim 1, the processor unit generates a frequency adjusting value based on the noise value, the processor unit adjusts the scan frequency or the display frequency based on the frequency adjusting value.

7. The electrical apparatus according to claim 6, wherein the touch controller generates the frequency adjusting value by comparing a threshold value and the noise value.

8. The electrical apparatus according to claim 1, further comprising:
a memory, coupled to the processor, wherein a table is saved in the memory, a plurality of scan frequency to be selected and a plurality of corresponding display frequency to be selected are arranged in the table, the processor unit determined one of the scan frequency to be selected to set the scan frequency, and the processor unit determined one of the display frequency to be selected corresponding to the scan frequency based on the table to set the display frequency.

9. The electrical apparatus according to claim 1, further comprising:
a memory, coupled to the processor, wherein a table is saved in the memory, a plurality of display frequency to be determined and a plurality of corresponding scan frequency to be selected are arranged in the table, the processor unit determines one of the display frequency to be selected to set the display frequency, and the processor unit determines one of the display frequency to be selected corresponding to the scan frequency based on the table to set the scan frequency.

10. The electrical apparatus according to claim 4, further comprising:
a memory, coupled to the processor, wherein a table is saved in the memory, a plurality of scan frequency to be selected and a plurality of corresponding display frequency to be selected are arranged in the table, the processor unit determines one of the scan frequency to be selected based on the noise value to adjust the scan frequency and set the display frequency based on the table and the scan frequency being adjusted

11. The electrical apparatus according to claim 5, further comprising:
a memory, coupled to the processor, wherein a table is saved in the memory, a plurality of scan frequency to be selected and a plurality of corresponding display frequency to be selected are arranged in the table, the processor unit determines one of the scan frequency to be selected based on the noise value to adjust the display frequency, and determines the scan frequency based on the table and the display frequency being adjusted.

12. The electrical apparatus according to claim 1, wherein the touch units are embedded in the display units.

13. The electrical apparatus according to claim 12, wherein in the display units comprising:
a color filer layer;
a thin film transistor array layer,
wherein the touch units comprise a first conductive layer, wherein the first conductive layer is coupled between the color filter layer and the thin film transistor array layer, the first conductive layer is coupled to the sense circuitry, the sense circuitry detects the touch units through the first conductive layer based on the scan frequency.

14. The electrical apparatus according to claim 12, wherein the display units comprise a color filter layer, the touch units comprise a first conductive layer, wherein the first conductive layer is coupled to the color filter layer, the first conductive layer is coupled to the sense circuitry, detects the touch units through the first conductive layer based on the scan frequency.

15. An electrical apparatus, which comprising:
a panel, which comprises a plurality of touch units and a plurality of display units;
a sense circuitry, which determines a scan frequency, the sense circuitry is coupled to the panel, the sense circuitry scan the touch unit in the panel based on the scan frequency; and
a drive circuitry, which determined a display frequency, the display driver is coupled to the sense circuitry and scans the display units in the panel for display an image based on the display frequency;
wherein the sense circuitry detects a noise value of the touch units, the sense circuitry adjusts the scan frequency or the display frequency based on the noise value.

16. The electrical apparatus according to claim 15, wherein the sense circuitry determines the scan frequency and generates the display frequency based on the scan frequency set by the sense circuitry.

17. The electrical apparatus according to claim 15, wherein the drive circuitry determines the display frequency and generates the scan frequency based on the display frequency determined by the drive circuitry.

18. The electrical apparatus according to claim 15, wherein the sense circuitry adjusts the scan frequency based on the noise value and tunes the display frequency based on the scan frequency being adjusted.

19. The electrical apparatus according to claim 15, wherein the sense circuitry adjusts the display frequency based on the noise value and generates the scan frequency based on the display frequency being adjusted.

20. The electrical apparatus according to claim 15, wherein the sense circuitry generates a frequency adjusting value based on the noise value, and the sense circuitry adjusts the scan frequency or the display frequency based on the frequency adjusting value.

21. The electrical apparatus according to claim 20, wherein the sense circuitry generates a frequency adjusting value based on a comparison between a threshold value and the noise value.

22. The electrical apparatus according to claim 15, further comprising:
a memory, coupled to the sense circuitry, wherein a table is saved in the memory, a plurality of scan frequency to be selected and a plurality of corresponding display frequency to be selected are arranged in the table, the sense circuitry determines one of the scan frequency to be selected to set the scan frequency, and determines one of the display frequency to be selected corresponding to the scan frequency based on the table to set the display frequency.

23. The electrical apparatus according to claim 15, further comprising:
a memory, coupled to the drive circuitry, wherein a table is saved in the memory, a plurality of display frequency to be selected and a plurality of corresponding scan frequency to be selected are arranged in the table, the drive circuitry determines one of the display frequency to be selected to set the display frequency, and selects one of the display frequency to be selected corresponding to the scan frequency based on the table to set the scanning frequency.

24. The electrical apparatus according to claim 18, further comprising:
a memory, coupled to the touch controller, wherein a table is saved in the memory, a plurality of scan frequency to be selected and a plurality of corresponding display frequency to be selected are arranged in the table, the sense circuitry determines one of the scan frequency to be selected based on the noise value to adjust the scan frequency, and sets the display frequency based on the table and the scan frequency being adjusted.

25. The electrical apparatus according to claim 17, further comprising:
a memory, coupled to the drive circuitry, wherein a table is saved in the memory, a plurality of scan frequency to be selected and a plurality of corresponding display frequency to be selected are arranged in the table, the sense circuitry determines one of the scan frequency to be selected based on the noise value to set the display frequency, and determines the scan frequency based on the table and the display frequency being adjusted.

26. The electrical apparatus according to claim 15, wherein the touch units are embedded in the display units.

27. The electrical apparatus according to claim 26, wherein the display units comprise:
a color filter layer;
a thin film transistor array layer,
wherein the touch units comprise a first conductive layer, wherein the first conductive layer is coupled between the color filter layer and the thin film transistor array layer, the first conductive layer is coupled to the sense circuitry, scans the touch units through the first conductive layer based on the scan frequency.

28. The electrical apparatus according to claim 26, wherein the display units comprise a color filter layer, the touch units comprise a first conductive layer, wherein the first conductive layer is coupled to the color filter layer, the first conductive layer is coupled to the sense circuitry, scan the first conductive layer detect the touch unit based on the scan frequency.

29. A method for determining a working frequency of an electrical apparatus, comprising:
determining one of a scan frequency and a display frequency to be a setting frequency and generating the other of the scan frequency and the display frequency based on the setting frequency; and
detecting a noise value of the electrical apparatus, adjusting the setting frequency based on the noise value and adjusting the scan frequency or the display frequency which is not the setting frequency based on the setting frequency.

30. The method for determining the working frequency according to claim 29, wherein the scan frequency is for the panel to detect a touch, and the display frequency is for the panel to display an image.

31. The method for determining the working frequency according to claim 29, wherein “detecting the noise detected value of the electrical apparatus and adjusting the setting frequency based on the noise detected value” comprises a step of:
adjusting the setting frequency being set according to a comparison between a threshold value and the noise value.

32. The method for setting the working frequency according to claim 30, wherein “adjusting the setting frequency based on the comparison between the threshold value and the noise detected value” comprises a step of:
adjusting the setting frequency being set when the noise value is not less than or greater than the threshold value.

33. The method for setting the working frequency according to claim 29, wherein the step “adjusting the setting frequency being set” is carried out through adding up or deducting a frequency adjusting value to/from an original frequency of the setting frequency.

34. The method for setting the working frequency according to claim 29, further comprising:
providing a frequency adjusting table, wherein the frequency adjusting table records a plurality of operatable scan frequency, setting the setting frequency through selecting one of the operatable scan frequency and adjusting the setting frequency through selecting the other of the operatable scan frequency.

35. The method for setting the working frequency according to claim 29, further comprising:
providing a frequency adjusting table, wherein the frequency adjusting table records a plurality of operatable display frequency for one of which to be selected to set the setting frequency and for the other of the operatble display frequency to be selected to adjust the setting frequency.

36. The method for setting the working frequency according to claim 29, wherein “generating the other of the scan frequency and the display frequency based on the setting frequency” further comprises a step of:
providing a frequency table, wherein the frequency table records a corresponding relation between the plurality of operatable display frequency and the plurality of operatable scan frequency; and
determining the display frequency through the frequency table based on the scan frequency which is the setting frequency, or, determining the scan frequency through the frequency table based on the display frequency which is the setting frequency.
